(19) United States
(12) Patent Application Publication
(10) Pub. No.: US 2009/0222355 A1
(43) Pub. Date: Sep. 3, 2009

(54) Process for toy rental service

(76) Inventor: Lori Lamb Pope, Houston, TX (US)

Correspondence Address: Latham, Wagner, Steele & Lehman, P.C.;Spirit Tower, 1800 South Baltimore, Suite 500, Tulsa, OK, 74119, US

(21) Appl. No.: 12/378,638

(22) Filed: Feb. 18, 2009

Related U.S. Application Data
(60) Provisional application No. 61/029,571, filed on Feb. 19, 2008.

(51) Int. Cl. G06Q 30/00; G06Q 50/00

(52) U.S. Cl. 705/26

(57) ABSTRACT

A toy rental service enabling parents, or other caregivers, to provide their children with a regularly changing variety of the most appropriate, safe and clean toys while eliminating the expense and time required to shop for and purchase such toys by conventional means.

I claim priority to my earlier filed provisional application number US61/029,571 (Feb. 19, 2008)

### BACKGROUND OF INVENTION

1. Field of the Invention

The claimed invention is a process for renting toys by means of the Internet.

2. Description of the Related Art

Examples are voluminous of persons engaged in the rental business. Rental services have been offered by means of the Internet. Toy co-ops and toy libraries have been described.

### BRIEF SUMMARY OF THE INVENTION

Parents often desire the best toys for their children. As babies grow and develop, they need different toys to stimulate learning and maintain interest. One result is that a home can easily become cluttered with toys that are seldom or never used. In addition, parents with busy schedules may find it too time consuming and cost-prohibitive to purchase new toys as often as they would like.

The claimed invention is a service that permits parents, or other caregivers, to rent clean and safe toys in excellent condition for a given time period and then exchange them for different ones. This service may be provided by means of the Internet, whereby a customer agrees to a subscription. The subscribing member agrees to pay a monthly fee in exchange for the service of receiving their pre-selected toys delivered directly to their residence. The subscriber may optionally purchase favorite toys at a discounted member rate. The member may choose from plans that vary according to the number of toys that are delivered each month. Plans may also vary according to the number of months of the committed subscription.

### BRIEF DESCRIPTION OF THE SEVERAL VIEWS OF THE DRAWINGS

One aspect of the invention, utilizing the Internet to conduct business, is described by two flow charts.

FIG. 1 is a flow chart detailing the process for subscribing to the service, selecting toys, and receiving fresh toys by means of the Internet.

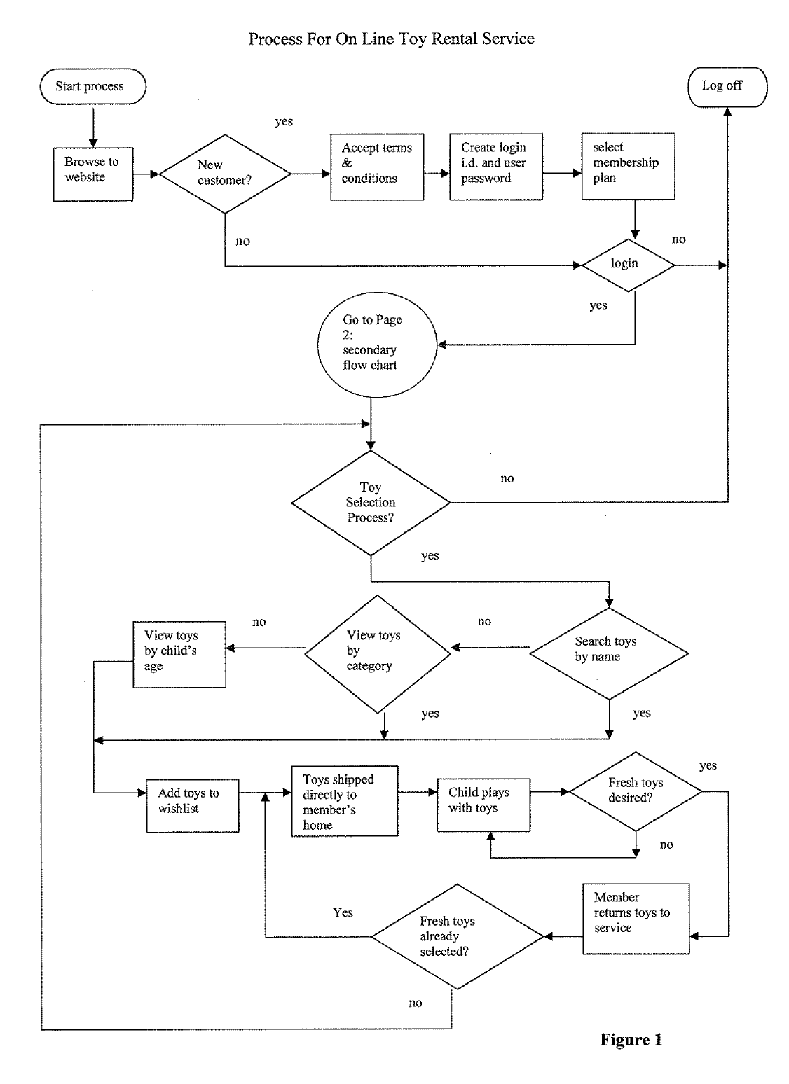

FIG. 2 is a flow chart detailing examples of support services, other than toy selection, that may be offered in connection with the process.

### DETAILED DESCRIPTION OF THE INVENTION

A toy rental service is disclosed.

The invention is a method for supplying families with growing children with a regularly changing variety of the most appropriate, safe, and clean toys while eliminating the expense and time required to shop for and purchase such toys by conventional means.

The preferred embodiment of the invention is a rental service that may be accessed by means of a personal computer and a browser connected to the Internet. New customers will be directed from the website to review and accept the terms and conditions of the rental agreement and use of the website. The member will then be prompted to create a secure access connection means such as a user ID and password. After a new customer becomes a registered member, a membership plan is selected.

Membership plans may vary according to the number of toys the member receives per month, and the period of subscription. Each membership plan would have a different cost which would be paid by means of a secured credit card charging program. After accessing the personal account, the member would be able to view thumbnail images of the toys that would be most appropriate for this or her child. The toy selection process would be simplified by a number of tools, such as sorting by age-appropriate grading of the toy, or by the type of toy, (i.e. rattles, crib toys, electronic toys) or by searching the name of the toy. The member would be able to quickly and easily select a number of toys to be stored as data in his or her “toy box” or account “wishlist.”

Upon payment of the first monthly installment of the subscription period, the rental service would ship the number of toys corresponding with the chosen plan (for example 6 toys) directly to the member's home. The child would have these toys to play with for a minimum of one month. A parent could keep any toy for a longer period than one month without penalty or additional charge. When a parent desired fresh toys, he or she would simply return the toys in a pre-paid shipping box, and receive fresh toys from the selected “wishlist.” The parent could optionally purchase certain toys at a discounted member price. A cycle of fresh, clean, interesting and age appropriate toys would be a great benefit and convenience for busy parents who desire the best toys for their children.

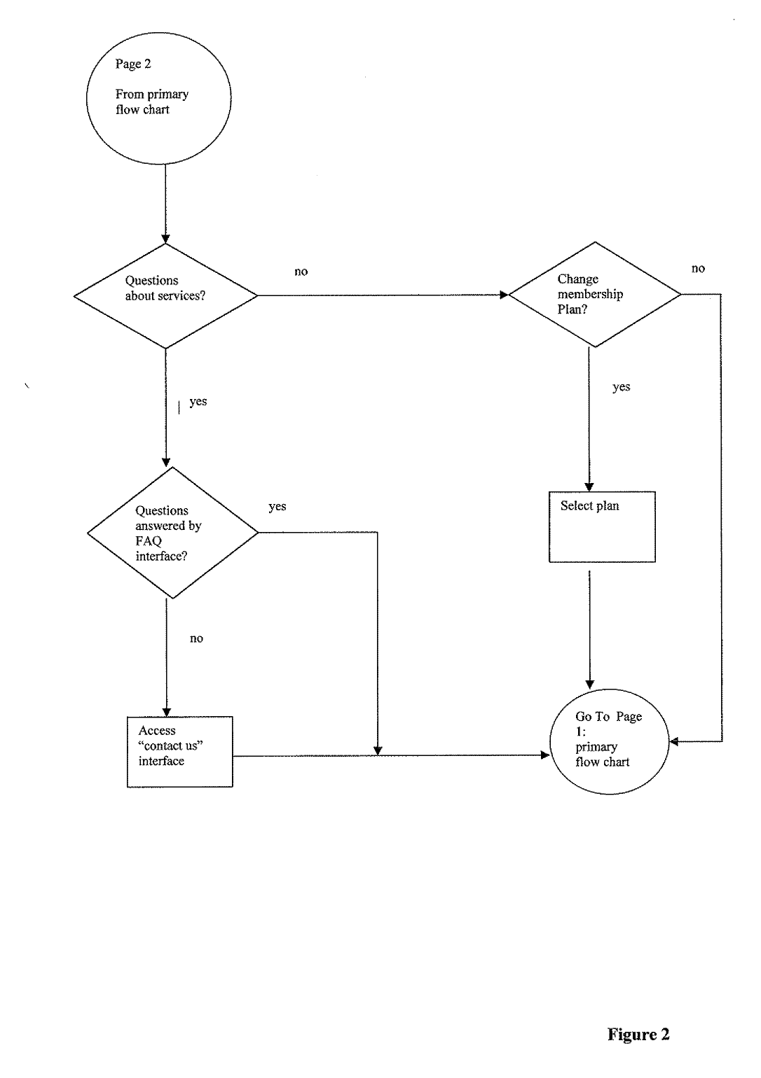

Other services could optionally be provided. FIG. 2. A website could permit changes to membership plans, and provide answers to frequently asked questions. Members and prospective customers could view F.A.Q. pages and communicate by electronic mail. Optional services could include charitable programs such as toy donation to needy families or families of soldiers.

1. I claim a toy rental service comprising the process of renting of children's toys including electronic toys, non-electronic toys, wooden toys, educational toys, building toys, the process comprises a monthly or bimonthly subscriptions through a website, which allows customers to choose as many toys as they wish and add them to a wishlist, customers choose a subscription plan which indicates the number of toys that they wish to receive from their wishlist each month, that number of toys is sent to the customer and the customer plays with the toys for as long as they want and may return them only when they are ready to have them replaced with more toys from their wishlist, when the customer is ready to return the toys, they ship them back to the company using the enclosed prepaid shipping label provided by the company.

2. I claim the process by which toys mentioned in claim 1 are sanitized and packaged for distribution: the process comprises a multi step sanitation and packaging process that toys undergo once returned by a customer: 1. Toys are inspected for wear and breakage 2. Surface dirt is cleaned off using a non-toxic all natural disinfectant and detailed cleaning is done using Q-Tips 3. Batteries are replaced and toys are sealed in clear shrink wrap and labeled as sanitized.

3. I claim the process of renting of children's toys for distribution to vacation destinations, the process comprises: the rental of children's toys via a website which are shipped directly to the customers vacation destination, the delivery of these toys are at destinations such as hotels, rental properties, rental management companies and are secured by a one-time fee which includes rental of the toys and shipping charges, the box of toy are shipped directly to the destination specified by the customer and when the customer is ready to ship toys back, they replace them in the original shipping container and seal the container with the tape provided and attach the provided prepaid return shipping label.
